(19) United States
(12) Patent Application Publication
(10) Pub. No.: US 2006/0137828 A1
(43) Pub. Date: Jun. 29, 2006

(54) Die pickup apparatus

(75) Inventors: Kazuhiro Fujisawa, Nishitokyo-shi (JP); Yutaka Odaka, Akiruno-shi (JP)

Correspondence Address: KODA & ANDROLIA, 2029 CENTURY PARK EAST, SUITE 1140, LOS ANGELES, CA, 90067, US

(73) Assignee: Kabushiki Kaisha Shinkawa

(21) Appl. No.: 11/134,752

(22) Filed: May 20, 2005

(30) Foreign Application Priority Data
May 31, 2004 (JP) 2004-160407

(51) Int. Cl. B29C 63/00; B23P 19/00

(52) U.S. Cl. 156/584; 29/426.1

(57) ABSTRACT

The object of the present invention is to make it possible to pick up dies securely using a die push-up member without damaging the dies.

A die push-up member 22 used for die-peeling which pushes the dies upward is disposed inside the suction holding stage 10 further toward the die feeding direction side than the die push-up member 21 used for die-pickup so that this die push-up member 22 can be move upward and downward. With the die push-up member 22 lowered, the die end portion (with respect to the die feeding direction) of the die 1A that is picked up is moved to above the die push-up member 22. Then, the die push-up member 22 is raised so that the die end portion (with respect to the die feeding direction) of the die 1A is peeled from the wafer sheet 2. Then, when the die push-up member 22 remaining in a raised state, the die 1A is fed to the pickup center 5, and is picked up by the collet 4 and die push-up member 21.

### TECHNICAL FIELD

The present invention relates to a die pickup apparatus which picks up dies from a wafer sheet by a collet.

### BACKGROUND ART

The push-up member system described in Patent Reference 1 is generally used as a pickup apparatus for dies pasted to a wafer sheet. In this apparatus, however, the problem of die damage may be encountered in cases where the thickness of the dies is approximately 100 μm or less.

In regard to measures used to alleviate this problem, Patent Reference 2 may be cited as an example of a method for picking up dies from a wafer sheet without using any die push-up members. In this apparatus, while suction is applied by means of a suction holding stage to a wafer sheet (which is a bonding sheet) to which dies are pasted, in a state in which a die is held by a collet, the suction holding stage is moved on the horizontal plane, after which the above-described collet picks up the above-described die from the above-described wafer sheet.
[Patent Reference 1] Japanese Patent Application Laid-Open (Kokai) No. H3-229441
[Patent Reference 2] Japanese Patent Application Laid-Open (Kokai) No. 2001-118862 (Japanese Patent No. 3209736)

### DISCLOSURE OF THE INVENTION

[Problems to Be Solved by the Invention]

Patent Reference 1 suffers from the problem of damage to the dies; however, this technique is advantageous in that there are almost no die pickup errors. Patent Reference 2 does not cause any die damage. However, since the bonded wafer sheet and dies are respectively held by vacuum suction of a suction holding stage and collet, and the wafer sheet and the dies are separated by causing the suction holding stage to move horizontally, it is necessary to strengthen the vacuum suction force, and this causes the problem of a deleterious effect on the dies.

The object of the present invention is to provide a die pickup apparatus which can securely pick up dies without damaging the dies even when a die push-up member is used.

[Means Used to Solve the Problems]

The invention of claim 1 that is used to solve the above-described problem is a die pickup apparatus comprising a suction holding stage that suction-holds a wafer sheet on which dies are pasted, a die push-up member used for die-pickup which is disposed in this suction holding stage and pushes up a die, and a collet which suction-holds a die that is pushed up by the die push-up member used for die-pickup and which conveys the dies, this die pickup apparatus being characterized by the fact that a die push-up member used for die-peeling which pushes up the die is installed inside the above-described suction holding stage on the die feeding side with respect to the above-described die push-up member used for die-pickup so that this die push-up member used for die-peeling is movable upward and downward, and with this die push-up member used for die-peeling lowered, the die end portion of the die which is to be picked up located on the die feeding direction side is moved to above the above-described die push-up member used for die-peeling, this die push-up member used for die-peeling is then raised so that the die end portion of the die located on the die feeding direction side is peeled from the above-described wafer sheet, and the die is subsequently fed with the die push-up member used for die-peeling raised, so that the die is partially or entirely peeled, after which the die is picked up.

The invention of claim 2 that is used to solve the above-described problem is a die pickup apparatus comprising a suction holding stage that suction-holds a wafer sheet on which dies are pasted, a die push-up member used for die-pickup which is disposed in this suction holding stage and pushes up a die, and a collet which suction-holds a die that is pushed up by the die push-up member used for die-pickup and which conveys the dies, this die pickup apparatus being characterized by the fact that a die push-up member used for die-peeling which pushes up the die is installed inside the above-described suction holding stage on the die feeding side with respect to the above-described die push-up member used for die-pickup so that this die push-up member used for die-peeling is movable upward and downward, and with this die push-up member used for die-peeling lowered, the die end portion of the die which is to be picked up located on the die feeding direction side is moved to above the above-described die push-up member used for die-peeling, this die push-up member used for die-peeling is then raised so that the die end portion of the die located on the die feeding direction side is peeled from the above-described wafer sheet, and the die is subsequently fed after the above-described die push-up member used for die-peeling is lowered, so that the die is partially or entirely peeled, after which the die is picked up.

The invention of claim 3 that is used to solve the above-described problem is a die pickup apparatus comprising a suction holding stage that suction-holds a wafer sheet on which dies are pasted, a die push-up member used for die-pickup which is disposed in a pickup center in this suction holding stage and pushes up a die, and a collet which suction-holds a die that is pushed up by the die push-up member used for die-pickup and which conveys the dies, this die pickup apparatus being characterized by the fact that suction holes are formed in the upper surface of the above-described suction holding stage on the die feeding side with respect to the above-described die push-up member used for die-pickup, and with the above-described die push-up member used for die-pickup lowered, the die end portion of the die which is to be picked up located on the die feeding direction side is moved to above the above-described die push-up member used for die-pickup, the above-described die push-up member used for die-pickup is then raised so that the die end portion of the die located on the die feeding direction side is peeled from the above-described wafer sheet, and the die is subsequently caused to move while riding over the above-described die push-up member used for die-pickup with the above-described die push-up member used for die-pickup remaining in the raised position, after which the above-described die is fed-back to the pickup center and picked up.

The invention of claim 4 that is used to solve the above-described problem is a die pickup apparatus comprising a suction holding stage that suction-holds a wafer sheet on which dies are pasted, a die push-up member used for die-pickup which is disposed in a pickup center in this suction holding stage and pushes up a die, and a collet which suction-holds a die that is pushed up by the die push-up member used for die-pickup and which conveys the dies, this die pickup apparatus being characterized by the fact that suction holes are formed in the upper surface of the above-described suction holding stage on the die feeding side with respect to the above-described die push-up member used for die-pickup, and with the above-described die push-up member used for die-pickup lowered, the die end portion of the die which is to be picked up located on the die feeding direction side is moved to above the above-described die push-up member used for die-pickup, the above-described die push-up member used for die-pickup is then raised so that the die end portion of the die located on the die feeding direction side is peeled from the above-described wafer sheet, the above-described die push-up member used for die-pickup is then lowered and the die end portion located on the die feeding direction side is moved to above the above-described suction holes, after which the above-described die is fed-back to the pickup center and picked up.

The invention of claim 5 that is used to solve the above-described problem is a die pickup apparatus comprising a suction holding stage that suction-holds a wafer sheet on which dies are pasted, a die push-up member used for die-pickup which is disposed in a pickup center in this suction holding stage and pushes up a die, and a collet which suction-holds a die that is pushed up by the die push-up member used for die-pickup and which conveys the dies, this die pickup apparatus being characterized by the fact that suction holes are formed in the upper surface of the above-described suction holding stage on the die feeding side with respect to the die push-up member used for die-pickup, and after the die end portion of the die which is to be picked up located on the die feeding direction side is moved to above the above-described suction holes, vacuum suction is applied to the above-described suction holding stage so that the die end portion of the die located on the above-described die feeding direction side is peeled from the above-described wafer sheet, and the die is subsequently fed-back to the die pickup center and picked up.

[Merits of the Invention]

Since the bonding strength between the die that is sent to the pickup center and the wafer sheet is reduced, no damage would occur to the die, which is thin, even if the die is pushed up by means of the die push-up member.

### BEST MODE TO CARRY OUT THE INVENTION

A first embodiment of the die pickup apparatus of the present invention will be described with reference to FIGS. 1 and 2. As shown in FIG. 1, the outer circumference of a wafer sheet 2 to which dies 1A, 1B, 1C . . . are pasted is fastened to a wafer ring (not shown in the drawings). The wafer ring is fastened to a wafer supporting frame (not shown in the drawings) which is driven horizontally in the directions of the X and Y axes. The dies 1A, 1B, 1C . . . are vacuum suction-held and picked up by means of a collet 4 in which a suction holding hole 3 is formed. A suction holding stage 10 which suction-holds the wafer sheet 2 by means of vacuum suction is disposed beneath the pickup center 5. The above art is known well.

A die push-up member 21 used for die-pickup is disposed in the pickup center 5 inside the suction holding stage 10 so that this die push-up member 21 is movable upward and downward. Die push-up members 22 and 23 used for die-peeling are disposed on both sides of this die push-up member 21 so that these die push-up members 22 and 23 are movable upward and downward. These die push-up members 21, 22 and 23 have a flat plate shape, and can be independently driven upward and downward by raising and lowering driving means not shown in the drawings. As shown in FIG. 2, the die push-up members 21, 22 and 23 are formed so that the lengths of these members in the direction perpendicular to the wafer sheet feeding direction A fall to the inside of the corner portions of the dies 1A, 1B and 1C, i.e., so that these die push-up members are shorter than the lengths of the sides of the dies 1A, 1B and 1C. Suction holes 11, 12 and 13 that act both as through-holes for the die push-up members 21, 22 and 23 and as suction holes for the wafer sheet 2 are formed in the suction holding stage 10.

Next, the die pickup method will be described. As shown in FIG. 1 (a), the vacuum of the suction holding stage 10 is switched on, and the wafer ring (not shown in the drawings) to which the wafer sheet 2 is fastened is moved so that the die end portion (with respective to the die feeding direction) of the die 1A that is to be picked up is moved to above the die push-up member 22. Next, as shown in FIG. 1 (b), the die push-up member 22 is raised, so that it pushes up the die end portion of the die 1A (with respective to the die feeding direction) via the wafer sheet 2. As a result, the die end portion of the die 1A (with respective to the die feeding direction) is peeled from the wafer sheet 2.

Next, as shown in FIG. 1 (c), with the die push-up member 22 still raised, the wafer sheet 2 is moved so that the die 1A is positioned in the pickup center 5. When the die 1A passes over the die push-up member 22, the die 1A is fed so that it rides over the peak portion pushed upward by the die push-up member 22; accordingly, the bonding strength between the wafer sheet 2 and die 1A drops. Next, as shown in FIG. 1 (d), the die push-up member 22 is lowered and separated from the wafer sheet 2, and the collet 4 is lowered to a position where this collet 4 suction-holds the die 1A. Then, as shown in FIG. 1 (e), the die push-up member 21 is raised so that this die push-up member 21 pushes the die 1A upward, and the collet 4 holds the die 1A by vacuum suction. In this case, since the bonding strength between the wafer sheet 2 and the die 1A has been lowered, the die 1A can easily be peeled from the wafer sheet 2 by the upward movement of the die push-up member 21 without being damaged.

The collet 4 that has picked up the die 1A by vacuum suction is moved upward and in the directions of the X and Y axes by a conveying means not shown in the drawings, and the next process, e.g., a process of die bonding, die packing or the like, is performed. When the die 1A is picked up, the die push-up member 21 is lowered as shown in FIG. 1 (f), and the wafer sheet 2 is caused to move so that the die end portion (with respective to the die feeding direction) of the die 1B that is to be picked up next is moved to above the die push-up member 22 as described above.

As seen from the above, since the bonding force between the wafer sheet 2 and the die 1A fed to the pickup center 5 has been lowered, the die 1A, which is thin, is not damaged when the die is pushed upward by the die push-up member 21.

Furthermore, in the above-described embodiment, the die push-up member 23 does not make any action at all. The reason for this is that a case was described in which a die was conveyed to the pickup center 5 from the left side. In cases where a die is conveyed to the pickup center 5 from the right side, the die push-up member 23 acts in the same manner as the die push-up member 22 described above, and the die push-up member 22 does not act at all.

A second embodiment of the die pickup apparatus of the present invention will be described with reference to FIG. 3. This embodiment is a modification of the first embodiment; in this embodiment, the processes of FIGS. 1 (c) and 1 (d) are changed to the processes of FIGS. 3 (a) and 3 (b). The rest of this embodiment is the same as in the processes shown in FIG. 1; accordingly, only the processes that are different will be described.

Following the process shown in FIG. 1 (a), the die end portion (with respective to the die feeding direction) of the die 1A is pushed upward by the die push-up member 22 as shown in FIG. 1 (b), so that the die end portion (with respect to the die feeding direction) of the die 1A is peeled from the wafer sheet 2; then, as shown in FIG. 3 (a), the die push-up member 22 is lowered. Subsequently, as shown in FIG. 3 (b), the wafer sheet 2 is moved so that the die 1A is positioned in the pickup center 5. Since the die end portion (with respect to the die feeding direction) of the die 1A is peeled from the wafer sheet 2 as described above, the die 1A is peeled from the wafer sheet 2 by the vacuum suction force of the suction hole 12 when the die 1A is moved as shown in FIGS. 3 (a) to 3 (b), so that the bonding strength between the wafer sheet 2 and die 1A is lowered. Subsequently, the processes shown in FIGS. 1 (e) and 1 (f) are performed.

In the present embodiment as in the above-described embodiment, since the bonding strength between the wafer sheet 2 and the die 1A conveyed to the pickup center 5 has been lowered, the die 1A, which is thin, is not damaged when the die 1A is pushed up by the die push-up member 21.

A third embodiment of the die pickup apparatus of the present invention will be described with reference to FIG. 4. Below, members that are the same as in FIGS. 1 through 3, or that correspond to members in FIGS. 1 through 3, are labeled with the same symbols, and a detailed description of such members is omitted. In this embodiment, a die push-up member 21 is disposed in the pickup center 5, and only suction holes 12 and 13 are disposed on both sides of the suction hole 11 of this die push-up member 21; die push-up members 22 and 23 are not disposed in the suction holes 12 and 13.

Next, the die pickup method will be described. As shown in FIG. 4 (a), the vacuum of the suction holding stage 10 is switched on, and the wafer sheet 2 is moved so that the die end portion (with respective to the die feeding direction) of the die 1A that is to be picked up is moved to above the die push-up member 21. Next, as shown in FIG. 4 (b), the die push-up member 21 is raised, so that the die end portion (with respective to the die feeding direction) of the die 1A is pushed upward via the wafer sheet 2. As a result, the die end portion (with respect to the die feeding direction) of the die 1A is peeled from the wafer sheet 2.

Next, as shown in FIG. 4 (c), with the die push-up member 21 remaining in a raised position, the wafer sheet 2 is moved so that the die 1A rides over the die push-up member 21. When the die 1A passes over the die push-up member 21, the die 1A is fed so that it rides over the peak portion pushed upward by the die push-up member 21; accordingly, the bonding strength between the wafer sheet 2 and die 1A drops. Subsequently, as shown in FIG. 4 (d), the die push-up member 21 is lowered, and the wafer sheet 2 is then moved so that the die 1A is positioned in the pickup center 5. Then, as shown in FIG. 4 (e), the die push-up member 21 is raised so that the die 1A is pushed upward, and the collet 4 holds the die 1A by vacuum suction. In this case, since the bonding strength between the wafer sheet 2 and the die 1A has been lowered, the die 1A can easily be peeled from the wafer sheet 2 by the upward movement of the die push-up member 21, so that the die 1A is not damaged.

The collet 4 that has picked up the die 1A by vacuum is moved upward and in the directions of the X and Y axes by a conveying means not shown in the drawings, and the next process, e.g., a process of die bonding, die packing or the like, is performed. When the die 1A is picked up, the die push-up member 21 is lowered as shown in FIG. 4 (f), and the wafer sheet 2 is caused to move so that the die end portion (with respective to the die feeding direction) of the die 1B that is to be picked up next is moved to above the die push-up member 21 as described above (see FIG. 4 (a)).

Thus, since the bonding force between the wafer sheet 2 and the die 1A fed-back to the pickup center 5 is lowered, the die 1A, which is thin, is not damaged when the die is pushed upward by the die push-up member 21.

A fourth embodiment of the die pickup apparatus of the present invention will be described with reference to FIG. 5. This embodiment is a modification of the third embodiment, in which the processes of FIGS. 4 (c) and 4 (d) are changed to the processes of FIGS. 5 (a) and 5 (b). The rest of this embodiment is the same as the processes shown in FIG. 4; accordingly, only the processes that are different will be described.

Following the process of FIG. 4 (a), the die end portion (with respect to the die feeding direction) of the die 1A is pushed upward by the die push-up member 21 as shown in FIG. 4 (b), so that this die end portion (with respect to the die feeding direction) of the die 1A is peeled from the wafer sheet 2; then, as shown in FIG. 5 (a), the die push-up member 21 is lowered, and the die 1A is fed in the die feeding direction so that all or part of the die 1A is peeled from the wafer sheet 2 by the negative pressure in the suction hole 11. Subsequently, as shown in FIG. 5 (b), the wafer sheet 2 is moved in the opposite direction from the die feeding direction A so that the die 1A is positioned in the pickup center 5. Since the die end portion (with respective to the die feeding direction) of the die 1A is peeled from the wafer sheet 2 as described above, the die 1A is peeled from the wafer sheet 2 by the vacuum suction force of the suction hole 12 when the die 1A is moved as shown in FIGS. 5 (a) to 5 (b), so that the bonding strength between the wafer sheet 2 and the die 1A drops. Subsequently, the processes of FIGS. 4 (e) and 4 (f) are performed.

In this embodiment as in the respective embodiments described above, since the bonding force between the wafer sheet 2 and the die 1A that is fed into the pickup center 5 is lowered, the die 1A, which is thin, is not damaged when the die 1A is pushed up by the die push-up member 21.

A fifth embodiment of the die pickup apparatus of the present invention will be described with reference to FIG. 6. In this embodiment, as in the above-described third and fourth embodiments, a die push-up member 21 is disposed in the pickup center 5, and only suction holes 12 and 13 are disposed on both sides of the suction hole 11 of this die push-up member 21; die push-up members 22 and 23 are not disposed in the suction holes 12 and 13. However, the action of the die push-up member 21 differs from that in the above-described third and fourth embodiments.

Next, the die pickup method will be described. As shown in FIG. 6 (a), the wafer sheet 2 is moved so that the end portion (with respect to the die moving direction) of the die 1A is moved to above the suction hole 12, and the vacuum of the suction holding stage 10 is switched on. As a result, as shown in FIG. 6 (b), the wafer sheet 2 is pulled downward at the die end portion (with respect to the die feeding direction) of the die 1A by the vacuum suction of the suction holding stage 10, so that the die end portion of the die 1A is peeled from the wafer sheet 2.

Next, as shown in FIG. 6 (c), the wafer sheet 2 is moved further so that the center of the die 1A is positioned in the pickup center 5. Since the end portion (with respect to the die feeding direction) of the die 1A has been peeled from the wafer sheet 2 as described above, the die 1A is peeled from the wafer sheet 2 by the vacuum suction force of the suction hole 12 when the die 1A is moved as shown in FIGS. 6 (b) to 6 (c), so that the bonding strength between the wafer sheet 2 and the die 1A drops. Subsequently, the processes shown in FIG. 6 (d) and 6 (e) are performed. Since these processes are the same as the processes of FIGS. 4 (e) and 4 (f), a description is omitted here.

In this embodiment as in the above-described embodiments, since the bonding strength between the wafer sheet 2 and the die 1A that is fed into the pickup center 5 is lowered, the die 1A, which is thin, is not damaged when the die 1A is pushed up by the die push-up member 21.

In the respective embodiments described above, a single die push-up member 21 used for die-pickup was provided. The sixth, seventh and eighth embodiments shown in FIGS. 7, 8 and 9 illustrate cases in which three die push-up members 24, 25 and 25 used for die-pickup are employed. FIG. 7 shows an example of application to the first embodiment shown in FIG. 1, FIG. 8 shows an example of application to the third embodiment shown in FIG. 4, and FIG. 9 shows an example of application to the fifth embodiment shown in FIG. 6. The die push-up members 24, 25 and 26 are fastened to a holder 30 which is driven upward and downward by raising and lowering driving means not shown in the drawings, and the central die push-up member 24 is formed with a height which is higher than the die push-up members 25 and 26 on both sides by a height value of h (approximately 100 to 150 μm). Suction holes 14, 15 and 16 are formed in the suction holding stage 10 corresponding to the die push-up members 24, 25 and 26. The remaining construction is the same as in the above-described applied figures; accordingly, the same or corresponding members are labeled with the same symbols, and a detailed description of such members is omitted.

A sixth embodiment of the die pickup apparatus of the present invention will be described with reference to FIG. 7. This embodiment is applied to the first embodiment shown in FIG. 1, and the action is almost the same as that shown in FIG. 1; accordingly, a detailed description of the same action will be omitted. Specifically, FIGS. 7 (a), 7 (b), 7 (c) and 7 (d) correspond to FIGS. 1 (a), 1 (b), 1 (c) and 1 (d); here, only the die push-up member 22 is raised and lowered, the die 1A is fed as shown in FIG. 1, and the bonding strength between the wafer sheet 2 and die 1A drops in the state shown in FIG. 7 (d).

Next, as shown in FIG. 7 (e), the holder 30 is raised so that the die 1A is pushed upward by the die push-up members 24, 25 and 26, and the collet 4 holds the die 1A by vacuum suction. In this case, the bonding strength between the wafer sheet 2 and the die 1A is lowered; accordingly, as in the case of FIG. 1, the die 1A can easily be peeled from the wafer sheet 2 by the upward movement of the die push-up members 24, 25 and 26 without being damaged. Furthermore, in this embodiment, since the die 1A is pushed upward by three die push-up members 24, 25 and 26, no excessive force is applied to the die 1A; moreover, even if the die is tilted by being pushed upward by the central die push-up member 24, the die is supported by one of the die push-up members 25 or 26 and is held by suction holding by the collet 4 through the vacuum suction of the suction holding hole 3 of the collet 4.

Subsequently, as shown in FIG. 7 (f), the die push-up members 24, 25 and 26 are lowered by the lowering of the holder 30, and the collet 4 holding the die 1A by suction holding performs the same operation as in a conventional apparatus; furthermore, as in the case of FIG. 1, the wafer sheet 2 is moved so that the die end portion (with respect to the die feeding direction) of the die 1B that is to be picked up next is moved to above the die push-up member 22 as described above.

A seventh embodiment of the die pickup apparatus of the present invention will be described with reference to FIG. 8. This embodiment is applied to the third embodiment shown in FIG. 4. As shown in FIG. 8 (a), the vacuum of the suction holding stage 10 is switched on, and the wafer sheet 2 is moved so that the die end portion (with respect to the die feeding direction) of the die 1A that is to be picked up is moved to above the central die push-up member 24. Next, as shown in FIG. 8 (b), when the holder 30 is raised, the die push-up member 24 pushes the die end portion (with respect to the die feeding direction) of the die 1A upward via the wafer sheet 2. As a result, the end portion (with respect to the die feeding direction) of the die 1A is peeled from the wafer sheet 2.

Next, as shown in FIG. 8 (c), with the holder 30, i.e., the die push-up member 24, in a raised state, the wafer sheet 2 is moved so that the die 1A rides over the die push-up member 24. When the die 1A passes over the die push-up member 24, the die 1A is fed so that it rides over the peak portion that is pushed upward by the die push-up member 24; accordingly, the bonding strength between the wafer sheet 2 and die 1A drops. Subsequently, as shown in FIG. 8 (d), the holder 30 is lowered, and the wafer sheet 2 is then caused to move so that the die 1A is positioned in the pickup center 5. Then, as shown in FIG. 8 (e), the holder 30 is raised so that the die push-up members 24, 25 and 26 push the die 1A upward, and the collet 4 holds the die 1A by vacuum suction. In this case, since the bonding strength between the wafer sheet 2 and die 1A is lowered, the die 1A can easily be peeled from the wafer sheet 2 by the upward movement of the die push-up members 24, 25 and 26 without being damaged (in the same manner as in the case of FIG. 4). Furthermore, in this embodiment, since the die 1A is pushed upward by three die push-up members 24, 25 and 26, no excessive force is applied to the die 1A, and even if the die is tilted by being pushed upward by the central die push-up member 24, the die is supported by one of the die push-up members 25 or 26 and is held by suction holding by the collet 4 through the vacuum suction of the suction holding hole 3 of the collet 4.

Subsequently, as shown in FIG. 8 (f), the die push-up members 24, 25 and 26 are lowered by the lowering of the holder 30, and the collet 4 holding the die 1A by suction holding performs an operation similar to that performed in a conventional apparatus; furthermore, the wafer sheet 2 is moved so that the die end portion (with respect to the die feeding direction) of the die 1B that is to be picked up next is moved to above the die push-up member 22 as described above (in the same manner as in the case of FIG. 1).

An eighth embodiment of the die pickup apparatus of the present invention will be described with reference to FIG. 9. This embodiment is applied to the fifth embodiment shown in FIG. 6, and the operation is almost the same as that in FIG. 6; accordingly, a detailed description of the same operation will be omitted. Specifically, FIGS. 9 (a), 9 (b) and 9 (c) correspond to FIGS. 6 (a), 6 (b) and 6 (c), and the bonding strength between the wafer sheet 2 and the die 1A is lowered in the state shown in FIG. 9 (c). Next, as shown in FIG. 9 (d), the holder 30 is raised so that the die push-up members 24, 25 and 26 push the die 1A upward, and the collet 4 holds the die 1A by vacuum suction. In this case, since the bonding strength between the wafer sheet 2 and the die 1A is lowered, the die 1A can easily be peeled from the wafer sheet 2 by the upward movement of the die push-up members 24, 25 and 26 without being damaged (in the same manner as in the case of FIG. 6). Furthermore, in this embodiment, since the die 1A is pushed upward by three die push-up members 24, 25 and 26, no excessive force is applied to the die 1A, and even if the die is tilted by being pushed upward by the central die push-up member 24, the die is supported by one of the die push-up members 25 or 26 and is held by suction holding by the collet 4 through the vacuum suction of the suction holding hole 3 of the collet 4.

Subsequently, as shown in FIG. 9 (e), the die push-up members 24, 25 and 26 are lowered by the lowering of the holder 30, and the collet 4 holding the die 1A by suction holding performs an operation similar to that performed in a conventional apparatus; furthermore, the wafer sheet 2 is moved so that the die end portion (with respect to the die feeding direction) of the die 1B that is to be picked up next is moved to above the suction hole 12 (in the same manner as in the case of FIG. 6).

In the first and sixth embodiments shown in the above-described FIGS. 1 and 7, as shown in FIGS. 1 (b), 1 (c), 7 (b) and 7 (c), when the entire die 1A is peeled away while the die push-up member 22 is raised, there may be cases in which the die 1A slips off of the wafer sheet 2. In order to prevent this, the die push-up member 22 is lowered before the rear end portion of the die 1A is peeled from the wafer sheet 2. The same is also true in the third embodiment shown in FIG. 4. Specifically, as shown in FIG. 4 (b), the wafer sheet 2 and die 1A are moved while the die push-up member 21 is raised, and the die push-up member 21 is lowered before the die 1A is entirely peeled away.

Furthermore, as shown in FIGS. 1 (b) and 7 (b), after the die end portion (with respect to the die feeding direction) of the die 1A is raised by the die push-up member 22, if the movement of the wafer sheet 2 is stopped for 100 to 200 msec, the peeling of the die 1A from the wafer sheet 2 is good.

Furthermore, as shown in FIGS. 1 (b) and 7 (b), in cases where the die end portion (with respect to the die feeding direction) of the die 1A is pushed upward by the die push-up member 22, the end portion (with respect to the die feeding direction) of the die 1A is more easily peeled if the amount of protrusion of the die push-up member 22 from the upper surface of the suction holding stage 10 is increased. For example, this amount of protrusion can be set at 250 μm. However, when the wafer sheet 2, i.e., the die 1A, is moved in the case of such a large amount of protrusion, there is a danger that the die 1A is damaged. In order to avoid this, it is preferable to lower the die push-up member 22 slightly following the states shown in FIGS. 1 (b) and 7 (b). For example, the amount of protrusion from the upper surface of the suction holding stage 10 can be set at 100 μm. This is also true in the case of FIG. 4. Specifically, as shown in FIG. 4 (b), the amount of protrusion of the die push-up member 21 from the upper surface of the suction holding stage 10 can be a large amount, and the die push-up member 21 is subsequently lowered by a slight amount.

The die push-up members 24, 25 and 26 used for die-pickup in the embodiments of FIGS. 7 and 9 have only the action of pushing up the die 1A (whose bonding strength with respect to the wafer sheet 2 has already been lowered) and causing this die 1A to be suction-held by the collet 4; accordingly, the die push-up members 24, 25 and 26 may all have the same height. However, in the embodiment shown in FIG. 8, the central die push-up member 24 lowers the bonding strength of the die with respect to the wafer sheet 2. Accordingly, in this embodiment, the die push-up member 24 must be formed with a height that is greater than the height of at least the die push-up member 25.

Furthermore, in the embodiments shown in FIGS. 7 through 9, a case in which three die push-up members 24, 25 and 26 are provided is described. However, the number of die push-up members used for die-pickup can be two or four or more. Furthermore, though this is not shown in the drawings, it goes without saying that the embodiment shown in FIG. 7 is applicable to the embodiment shown in FIG. 3 and the embodiment shown in FIG. 8 is applicable to the embodiment shown in FIG. 5.

### BRIEF DESCRIPTION OF THE DRAWINGS

FIG. 1 A sectional front view showing the first embodiment of the die pickup apparatus of the present invention.

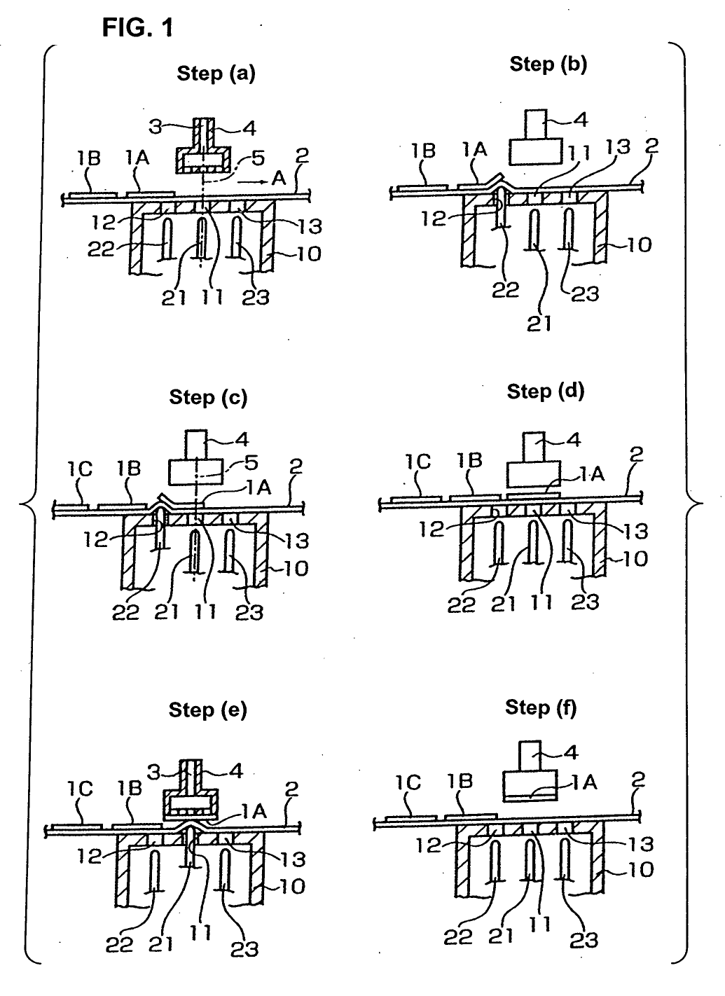

FIG. 2. A top view of the suction holding stage in FIG. 1.

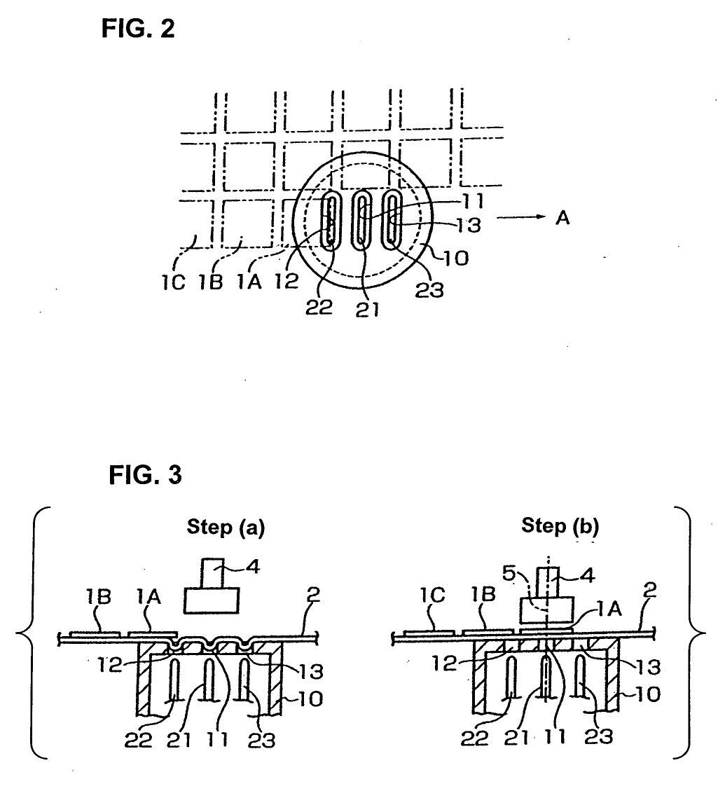

FIG. 3. A sectional front view showing the second embodiment of the die pickup apparatus of the present invention.

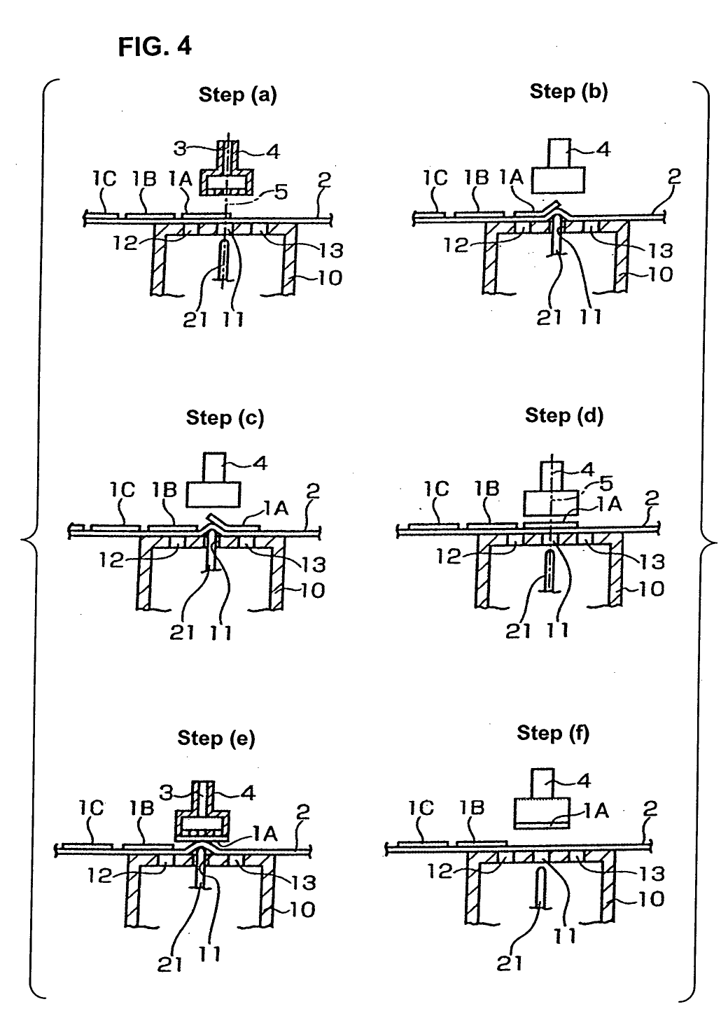

FIG. 4 A sectional front view showing the third embodiment of the die pickup apparatus of the present invention.

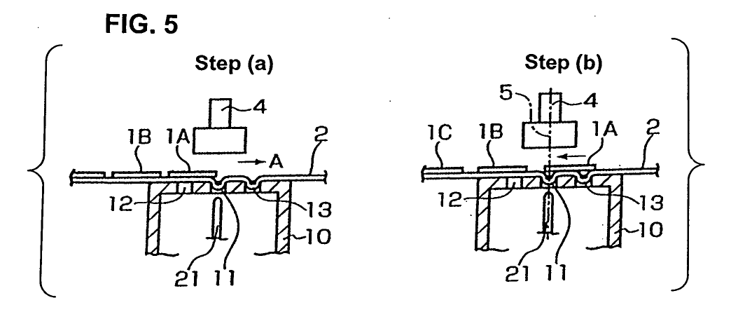

FIG. 5 A sectional front view showing the fourth embodiment of the die pickup apparatus of the present invention.

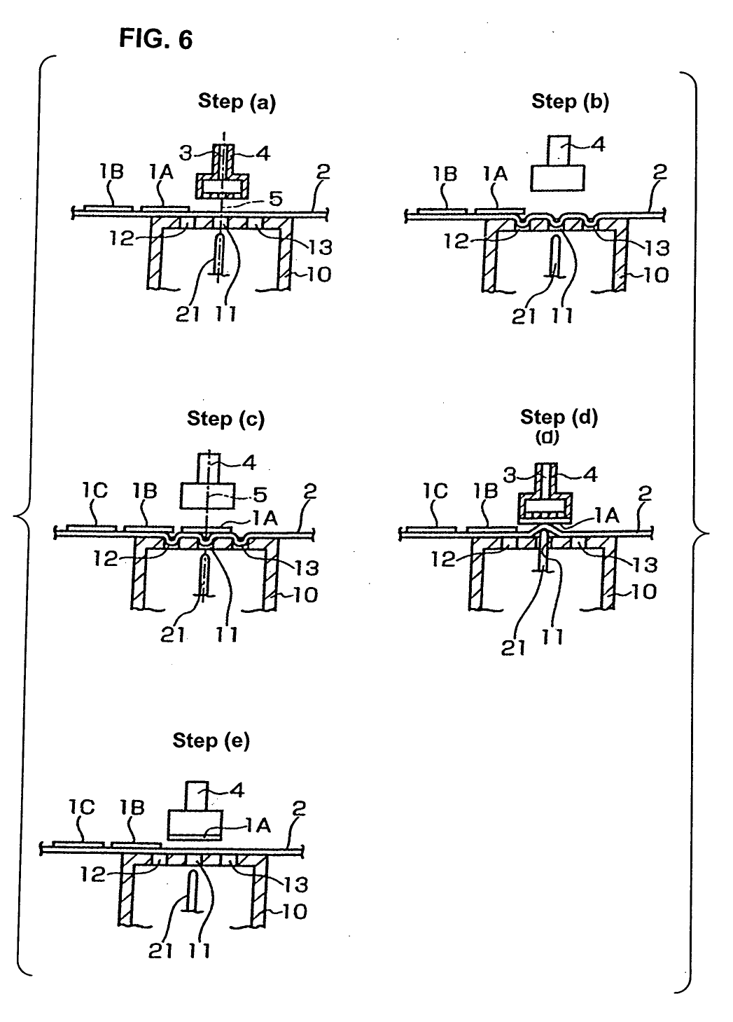

FIG. 6 A sectional front view showing the fifth embodiment of the die pickup apparatus of the present invention.

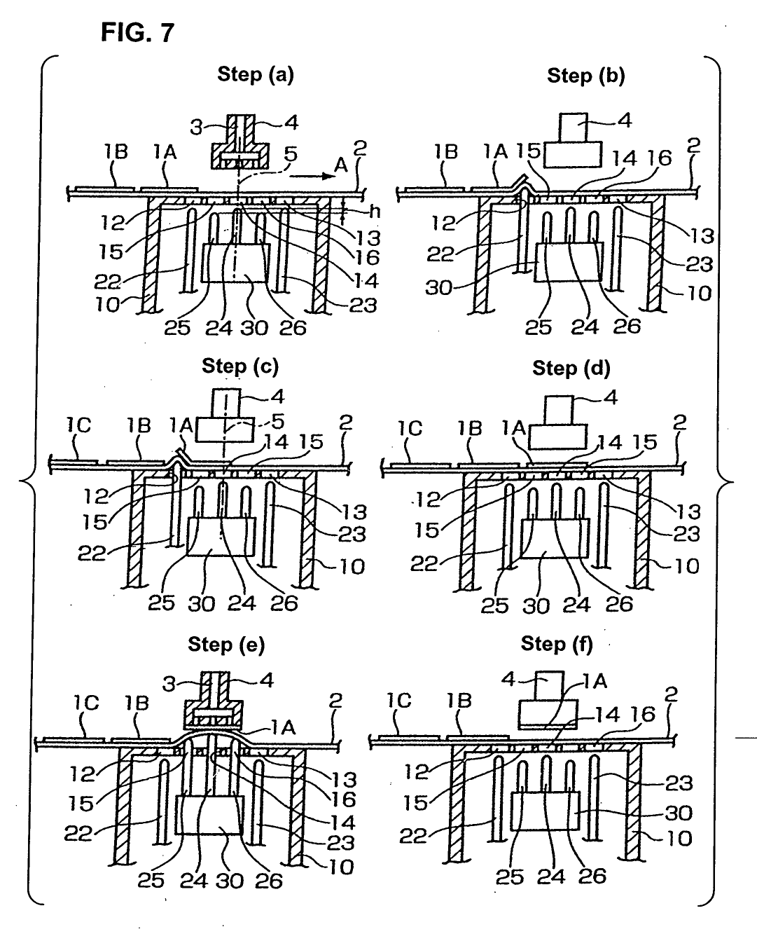

FIG. 7 A sectional front view showing the sixth embodiment of the die pickup apparatus of the present invention.

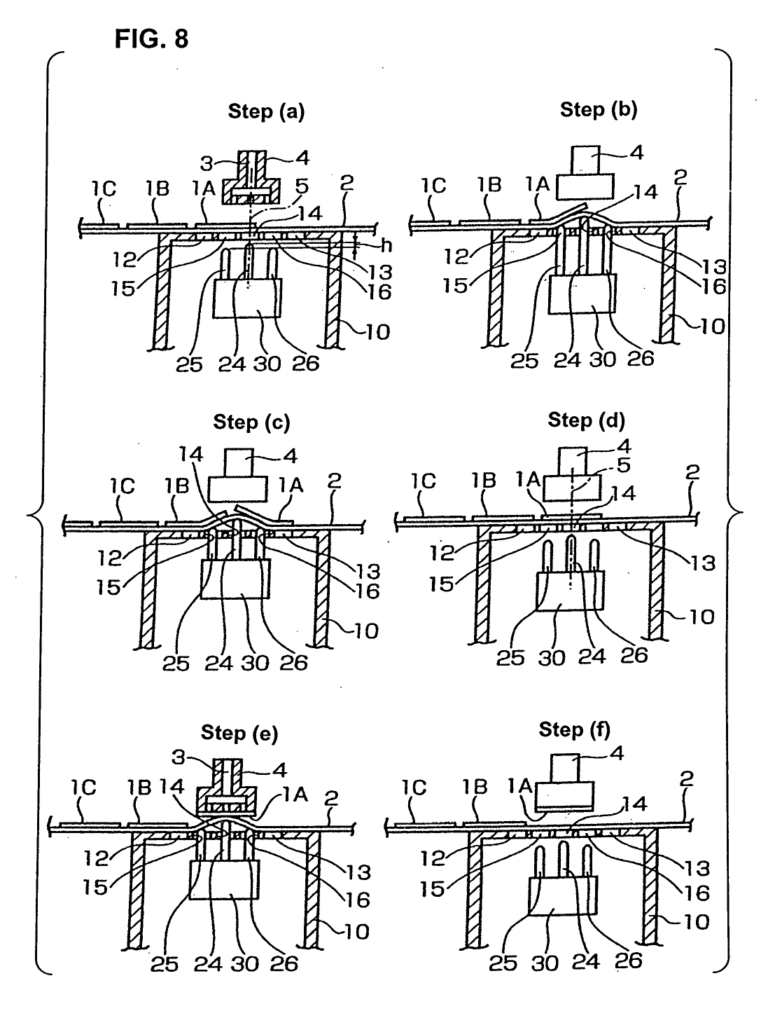

FIG. 8 A sectional front view showing the seventh embodiment of the die pickup apparatus of the present invention.

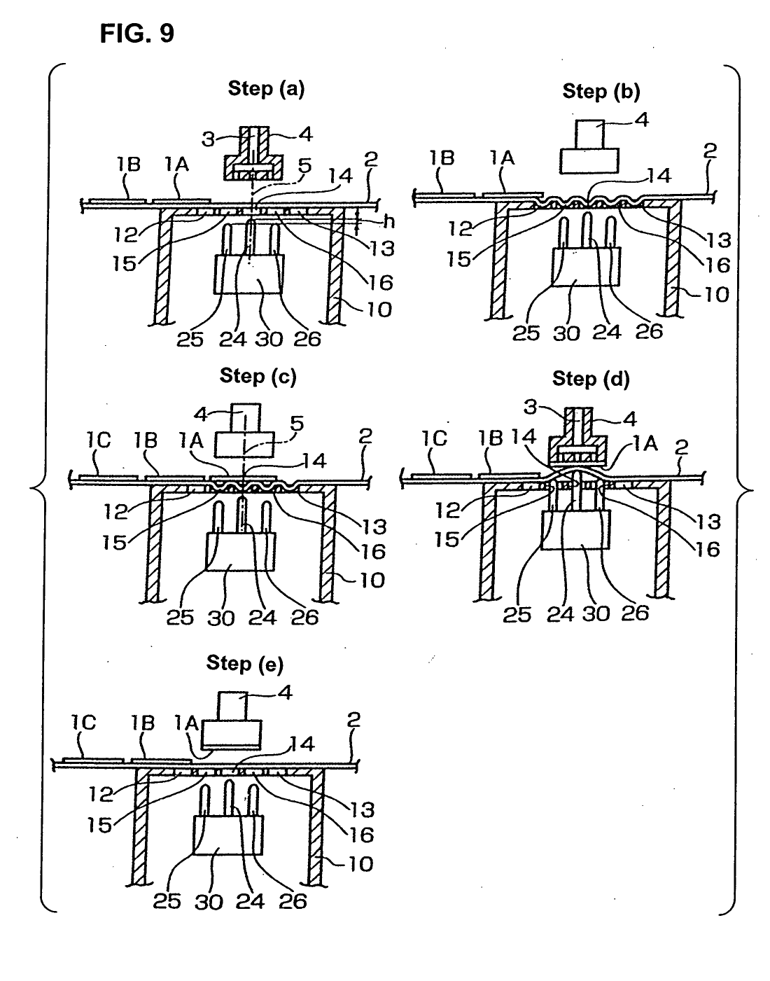

1. A die pickup apparatus comprising:
a suction holding stage that suction-holds a wafer sheet on which dies are pasted,
a die push-up member used for die-pickup which is disposed in said suction holding stage and pushes up a die, and
a collet which suction-holds a die that is pushed up by the die push-up member used for die-pickup and which conveys said die;
wherein said die-pickup apparatus further comprises a die push-up member used for die-peeling, said die push-up member used for die-peeling being movable upward and downward and provided inside said suction holding stage so as to be on a die feeding side with respect to said die push-up member used for die-pickup; and
wherein said die-pickup apparatus,
with said die push-up member used for die-peeling lowered, moves an end portion of a die which is to be picked up located on the die feeding direction side to above said die push-up member used for die-peeling,
raises said die push-up member used for die-peeling so that the end portion of the die located on the die feeding direction side is peeled from said wafer sheet,
subsequently feeds the die with said die push-up member used for die-peeling raised, so that the die is partially or entirely peeled, and
allows said collet to pick up the die.

2. A die pickup apparatus comprising:
a suction holding stage that suction-holds a wafer sheet on which dies are pasted,
a die push-up member used for die-pickup which is disposed in said suction holding stage and pushes up a die, and
a collet which suction-holds a die that is pushed up by the die push-up member used for die-pickup and which conveys said die;
wherein said die-pickup apparatus further comprises a die push-up member used for die-peeling, said die push-up member used for die-peeling being movable upward and downward and provided inside said suction holding stage so as to be on a die feeding side with respect to said die push-up member used for die-pickup; and
wherein said die-pickup apparatus,
with said die push-up member used for die-peeling lowered, moves an end portion of a die which is to be picked up located on the die feeding direction side to above said die push-up member used for die-peeling,
raises said die push-up member used for die-peeling so that the end portion of the die located on the die feeding direction side is peeled from said wafer sheet,
subsequently feeds the die after said die push-up member used for die-peeling is lowered, so that the die is partially or entirely peeled, and
allows said collet to pick up the die.

3. A die pickup apparatus comprising:
a suction holding stage that suction-holds a wafer sheet on which dies are pasted,
a die push-up member which is disposed at a pickup center in said suction holding stage and pushes up a die, and
a collet which suction-holds a die that is pushed up by the die push-up member and which conveys said die; wherein
said suction holding stage is provided with a suction hole in an upper surface thereof so that the suction hole is located at said pickup center of said suction holding stage; and
wherein said die pickup apparatus,
with said die push-up member lowered, moves an end portion of a die which is to be picked up located on the die feeding direction side to above said die push-up member,
raises said die push-up member so that the end portion of the die located on the die feeding direction side is peeled from said wafer sheet,
subsequently causes the die to move while riding over said die push-up member with said die push-up member remaining in a raised position,
feeds back said die to the pickup center, and
allows said collet to pick up the die.

4. A die pickup apparatus comprising:
a suction holding stage that suction-holds a wafer sheet on which dies are pasted,
a die push-up member which is disposed at a pickup center in said suction holding stage and pushes up a die, and
a collet which suction-holds a die that is pushed up by the die push-up member and which conveys said die; wherein
said suction holding stage is provided with a suction hole in an upper surface thereof so that the suction hole is located at said pickup center of said suction holding stage; and
wherein said die pickup apparatus,
with said die push-up member used for die pickup lowered, moves an end portion of a die which is to be picked up located on the die feeding direction side to above said die push-up member,
raises said die push-up member so that the end portion of the die located on the die feeding direction side is peeled from said wafer sheet,
subsequently lowers said die push-up member and moves the die end portion located on the die feeding direction side to above said suction hole,
feeds back said die to the pickup center, and
allows said collet to pick up the die.

5. A die pickup apparatus comprising:
a suction holding stage that suction-holds a wafer sheet on which dies are pasted,
a die push-up member which is disposed at a pickup center in said suction holding stage and pushes up a die, and
a collet which suction-holds a die that is pushed up by the die push-up member and which conveys said die; wherein
said suction holding stage is provided with a suction hole in an upper surface thereof so that the suction hole is located at said pickup center of said suction holding stage; and
wherein said die pickup apparatus,
moves an end portion of a die which is to be picked up located on the die feeding direction side to above said suction hole,
applies vacuum suction to said suction holding stage so that the end portion of the die located on said die feeding direction side is peeled from said wafer sheet,
subsequently feeds back the die to the pickup center, and
allows said collet to pick up the die.

6. The die pickup apparatus according to claim 1 or 2, wherein said die push-up member used for die-pickup is provided in a plurality of numbers.

7. The die pickup apparatus according to any of claims 3 through 5, wherein said die push-up member is provided in a plurality of numbers.

8. The die pickup apparatus according to claim 1 or 2, wherein said die push-up member used for die-pickup is provided three or more, and a die push-up member in a center is formed higher than push-up members on both sides.

9. The die pickup apparatus according to any of claims 3 through 5, wherein said die push-up member is provided three or more, and a die push-up member in a center is formed higher than push-up members on both sides.
